(19) United States
(12) Patent Application Publication
(10) Pub. No.: US 2026/0290646 A1
(43) Pub. Date: Sep. 24, 2026

(54) WATER STOP STRUCTURE, WIRE HARNESS, AND METHOD FOR MANUFACTURING WIRE HARNESS

(71) Applicant: Yazaki Corporation, Tokyo (JP)

(72) Inventors: Hiroki GOTOU, Shizuoka (JP); Eiichi TOHYAMA, Makinohara-shi (JP); Daisuke ITO, Shizuoka (JP); Hidekazu FUNAHASHI, Osaka (JP)

(73) Assignee: Yazaki Corporation, Tokyo (JP)

(21) Appl. No.: 19/412,425

(22) Filed: Dec. 8, 2025

(30) Foreign Application Priority Data
Dec. 9, 2024 (JP) 2024-214744

(51) Int. Cl. H01B 7/282; H01B 7/00; H01B 7/02; H01B 13/012; H01B 13/06

(52) U.S. Cl. CPC H01B 7/2825; H01B 7/0045; H01B 7/0266; H01B 13/01209; H01B 13/06

(57) ABSTRACT

A water stop structure includes a water stop portion provided on an electric wire bundle and stopping water between a grommet and the electric wire bundle obtained by bundling a plurality of electric wires. The water stop portion includes at least a pair of spacers mounted on an outer periphery of the electric wire bundle at a position including a water stop section that requires water stop between the grommet and the electric wire bundle, and disposed at an interval in a longitudinal direction of the electric wire bundle, a tubular braid covering the outer periphery of the electric wire bundle including the spacers, and a resin covering the outer periphery of the electric wire bundle in the water stop section together with the spacers and the braid.

### CROSS-REFERENCE TO RELATED APPLICATIONS

This application is based on and claims priority under 35 USC 119 from Japanese Patent Application No. 2024-214744 filed on Dec. 9, 2024, the contents of which are incorporated herein by reference.

### TECHNICAL FIELD

The present invention relates to a water stop structure, a wire harness, and a method for manufacturing a wire harness.

### BACKGROUND ART

Patent Literature 1 discloses a technique related to water stop for filling a gap between a water stop portion of a wire harness and a tube portion of a grommet externally fitted to the water stop portion. Patent Literature 1 discloses that, on an electric wire bundle in a region where the tube portion of the grommet of the wire harness is externally fitted, the water stop portion made of a thermoplastic resin that covers the electric wire bundle is formed, the tube portion of the grommet is externally fitted to the water stop portion, and then at least an outer peripheral portion of the water stop portion is softened by heating.

### CITATION LIST

### Patent Literature

Patent Literature 1: Jp2012-85387 A

### SUMMARY OF INVENTION

### Technical Problem

In a power supply wire harness including an electric wire bundle of large-diameter electric wires such as high-voltage electric wires, noise is suppressed by covering an outer peripheral portion of the electric wire bundle with a braid to shield the electric wire bundle. In this kind of wire harness, even when the water stop portion is molded by molding a resin on the outer periphery of a position of the electric wire bundle to which the braid is mounted, the resin may not sufficiently penetrate between the electric wire and the braid, and water stop performance may not be ensured.

The present invention has been made in view of the above-described circumstances, and an object thereof is to provide a water stop structure, a wire harness, and a method for manufacturing a wire harness that can ensure good water stop performance in a water stop section between a water stop member and an electric wire bundle having a braid covering an outer periphery.

### Solution to Problem

The above object of the present invention is achieved by the following configuration. A water stop structure includes a water stop portion for stopping water between a water stop member and an electric wire bundle obtained by bundling a plurality of electric wires. The water stop is provided on the electric wire bundle. The water stop portion includes at least a pair of spacers mounted on an outer periphery of the electric wire bundle at a position including a water stop section that requires water stop between the water stop member and the electric wire bundle, and disposed at an interval in a longitudinal direction of the electric wire bundle, a tubular braid covering the outer periphery of the electric wire bundle including the spacers, and a resin covering the outer periphery of the electric wire bundle in the water stop section together with the spacers and the braid.

A method for manufacturing a wire harness in which a water stop portion for stopping water between a water stop member and an electric wire bundle obtained by bundling a plurality of electric wires is provided on the electric wire bundle is provided. The method includes a spacer placing step of mounting at least a pair of spacers on an outer periphery of the electric wire bundle and disposing the spacers at an interval in a longitudinal direction of the electric wire bundle at a position in the electric wire bundle including a water stop section that requires water stop between the water stop member and the electric wire bundle; a braid mounting step of covering the outer periphery of the electric wire bundle including the spacers with a tubular braid; and a forming step of filling with a resin so as to cover the water stop section in the electric wire bundle to form the water stop portion.

### Advantageous Effects of Invention

According to the present invention, it is possible to provide a water stop structure, a wire harness, and a method for manufacturing a wire harness that can ensure good water stop performance in a water stop section between a water stop member and an electric wire bundle having a braid covering an outer periphery.

The present invention has been briefly described above. Details of the present invention can be clarified by reading modes (hereinafter, referred to as “embodiments”) for carrying out the invention to be described below with reference to the attached drawings.

### BRIEF DESCRIPTION OF DRAWINGS

FIG. 1 is a perspective view of a water stop portion of a wire harness provided with a water stop structure according to the present embodiment.

FIG. 2 is a perspective view of the water stop portion with a resin removed.

FIG. 3 is a perspective view of the water stop portion with the resin and a braid removed.

FIG. 4 is a cross-sectional view taken along a axial direction of the wire harness in a state in which the water stop portion is fitted into a seal hole of a grommet.

FIG. 5 is a cross-sectional view taken along the axial direction of the wire harness in the middle of manufacturing for illustrating a manufacturing process of the wire harness.

FIG. 6 is a cross-sectional view taken along the axial direction of the wire harness in the middle of manufacturing for illustrating the manufacturing process of the wire harness.

FIG. 7 is a cross-sectional view taken along the axial direction of the wire harness in the middle of manufacturing for illustrating the manufacturing process of the wire harness.

FIG. 8 is a cross-sectional view taken along the axial direction of the wire harness in the middle of manufacturing for illustrating the manufacturing process of the wire harness.

FIG. 9 is a cross-sectional view taken along a radial direction of the wire harness in the middle of manufacturing for illustrating the manufacturing process of the wire harness.

FIG. 10 is a cross-sectional view taken along the radial direction of the wire harness in the middle of manufacturing for illustrating the manufacturing process of the wire harness.

FIG. 11 is a cross-sectional view taken along the radial direction of the wire harness in the middle of manufacturing for illustrating the manufacturing process of the wire harness.

FIG. 12 is a cross-sectional view taken along the radial direction of the wire harness in the middle of manufacturing for illustrating the manufacturing process of the wire harness.

### DESCRIPTION OF EMBODIMENTS

Specific embodiments of the present disclosure will be described below with reference to the drawings.

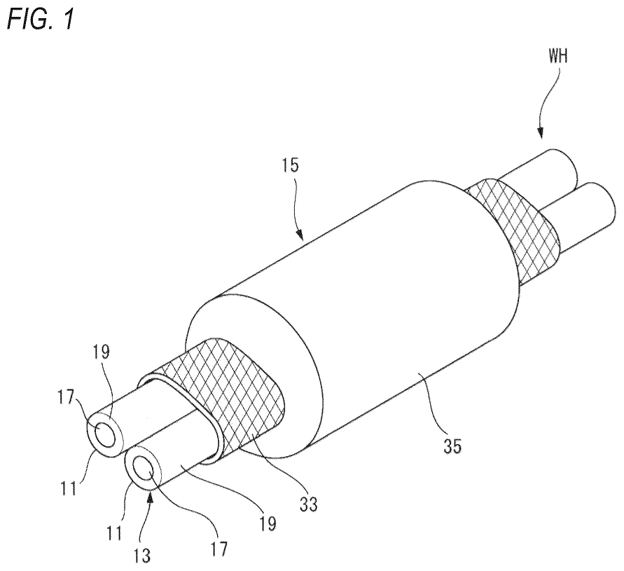

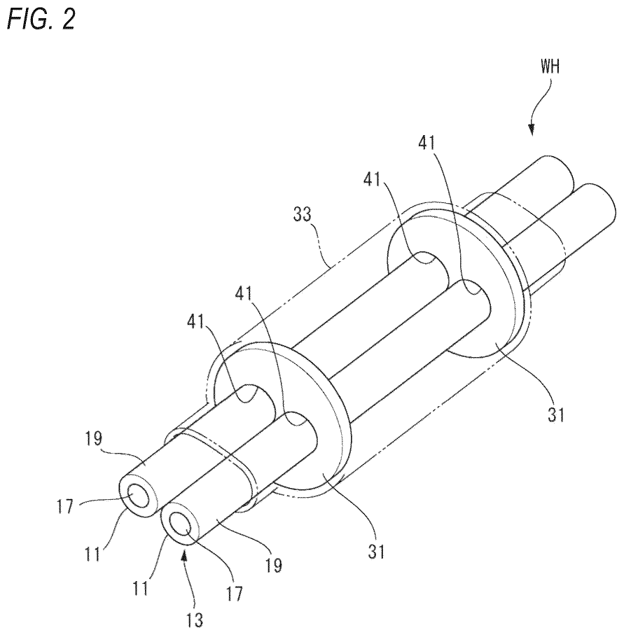

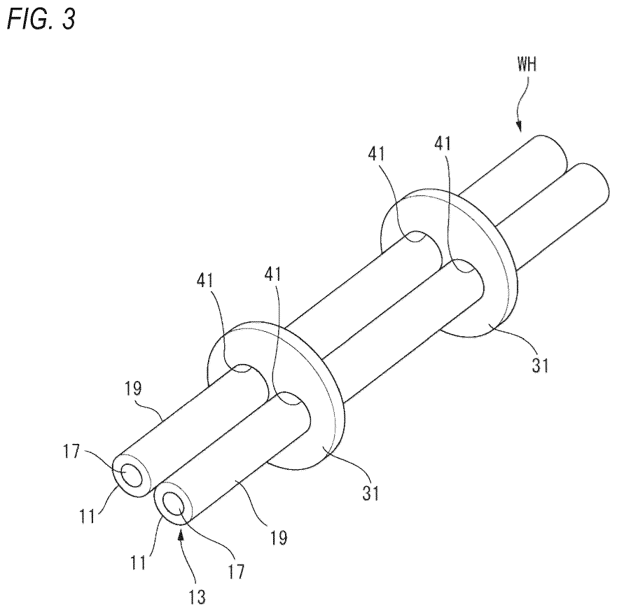

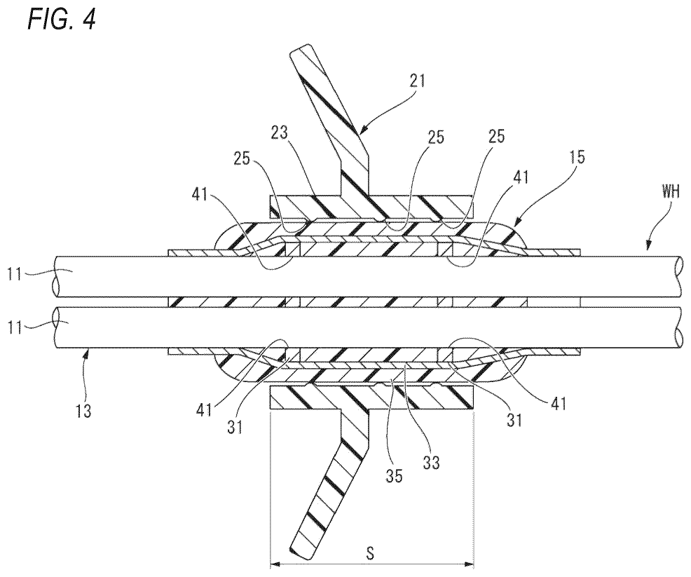

FIG. 1 is a perspective view of a water stop portion 15 of a wire harness WH provided with a water stop structure according to the present embodiment. FIG. 2 is a perspective view of the water stop portion 15 with a resin 35 removed. FIG. 3 is a perspective view of the water stop portion 15 with the resin 35 and a braid 33 removed. FIG. 4 is a cross-sectional view taken along an axial direction of the wire harness WH in a state in which the water stop portion 15 is fitted into a seal hole 23 of a grommet 21.

As illustrated in FIGS. 1 to 3, the water stop structure according to the present embodiment is applied to the wire harness WH. The wire harness WH is routed in, for example, a vehicle such as an automobile for power supply. The wire harness WH includes an electric wire bundle 13 formed by bundling a plurality of electric wires 11, and the electric wire bundle 13 is provided with the water stop portion 15. In this example, the wire harness WH includes the electric wire bundle 13 formed by bundling two electric wires 11. The electric wires 11 constituting the electric wire bundle 13 are, for example, large-diameter electric wires such as high-voltage electric wires. Each electric wire 11 is an insulated electric wire in which a core wire 17 made of a conductor is covered with a sheath 19. The number of electric wires 11 of the electric wire bundle 13 is not limited to two, and may be three or more.

As illustrated in FIG. 4, the water stop portion 15 includes a pair of spacers 31, the braid 33, and the resin 35. The water stop portion 15 of the wire harness WH is provided to stop water between the grommet (water stop member) 21 and the electric wire bundle 13, and is formed in a columnar shape. The grommet 21 has a tubular seal hole 23. The wire harness WH is passed through the seal hole 23 of the grommet 21, and the water stop portion 15 is fitted into the seal hole 23. A plurality of lip portions 25 protruding radially inward are formed along a circumferential direction on an inner periphery of the seal hole 23. These lip portions 25 are disposed at intervals in the axial direction, and are in close contact with an outer peripheral surface of the water stop portion 15 fitted into the seal hole 23. Accordingly, water in a water stop section S in a longitudinal direction of the seal hole 23 is stopped by the wire harness WH and the grommet 21.

Each spacer 31 is formed of, for example, an insulating resin and has a substantially disk shape. The spacer 31 has a diameter larger than an outermost diameter of the electric wire bundle 13. The spacer 31 has the same number of hole portions 41 as the electric wires 11, and the electric wires 11 are inserted into these hole portions 41. Accordingly, the pair of spacers 31 are mounted on an outer periphery of the electric wire bundle 13 at an interval in the longitudinal direction of the electric wire bundle 13. The electric wires 11 inserted into the hole portions 41 of the spacer 31 are disposed with gaps formed between them along the longitudinal direction.

The braid 33 is formed by braiding strands made of, for example, an annealed copper wire having a small diameter of about 0.12 mm to 0.32 mm, and is formed in a tubular shape. The electric wire bundle 13 is passed through the braid 33. The braid 33 covers the outer periphery of the electric wire bundle 13 including the spacers 31 as a shield member for suppressing noise. The braid 33 mounted on the electric wire bundle 13 is expanded in diameter by the spacers 31. Accordingly, a gap between the braid 33 and the electric wire 11 is increased, and a mesh of the braid 33 is widened.

The resin 35 is provided on the outer periphery of the electric wire bundle 13 in the water stop section S, and the electric wire bundle 13 is covered with the resin 35 together with the spacers 31 and the braid 33. Accordingly, the electric wire bundle 13 is in a state in which the resin 35 is filled between the electric wires 11, between the electric wires 11 and the braid 33, in the mesh of the braid 33, and on an outer peripheral side of the braid 33 (see FIG. 4). As the resin 35, for example, a thermoplastic resin is used.

As described above, according to the water stop structure of the present embodiment, by mounting the spacer 31 on the outer periphery of the electric wire bundle 13, a gap is formed between the electric wire bundle 13 and the braid 33, and the braid 33 is expanded in diameter to widen the mesh of the braid 33. Accordingly, in the water stop portion 15, the resin 35 covering the water stop section S is sufficiently interposed between the electric wire bundle 13 and the braid 33 and enters the mesh of the braid 33. Therefore, by covering the outer periphery with the braid 33, it is possible to ensure good water stop performance in the water stop section S while obtaining a shielding function.

Further, since the spacer 31 has the hole portions 41 through which the electric wires 11 are respectively inserted, a gap is formed between the electric wires 11 inserted into the hole portions 41. Therefore, in the water stop portion 15, the resin 35 is filled in the gap between the electric wires 11, and better water stop performance can be ensured.

According to the wire harness WH including the water stop structure, since good water stop performance in the water stop portion 15 including the water stop section S is ensured, when the wire harness WH is passed through the seal hole 23 of the grommet 21, water can be satisfactorily stopped in the water stop section S between the wire harness WH and the grommet 21.

After the water stop portion 15 is fitted into the seal hole 23 of the grommet 21, the water stop section S may be heated to soften the resin 35. In this way, an inner peripheral surface of the seal hole 23 having the lip portions 25 can be more satisfactorily brought into close contact with the outer peripheral surface of the water stop portion 15 to improve the water stop performance.

Next, a method for manufacturing the wire harness WH including the water stop structure will be described.

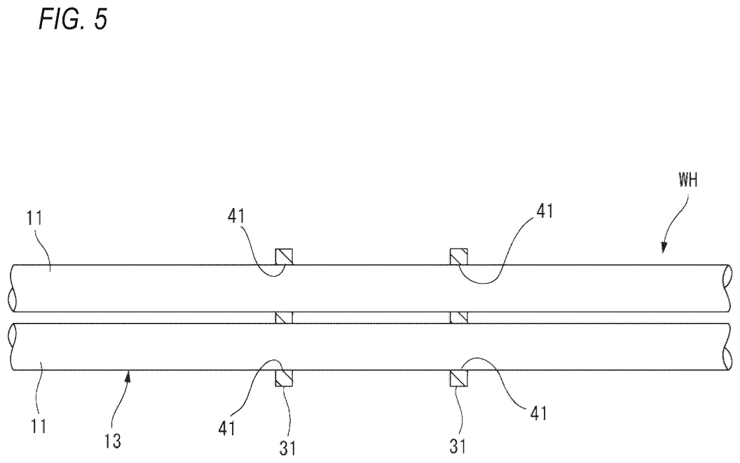

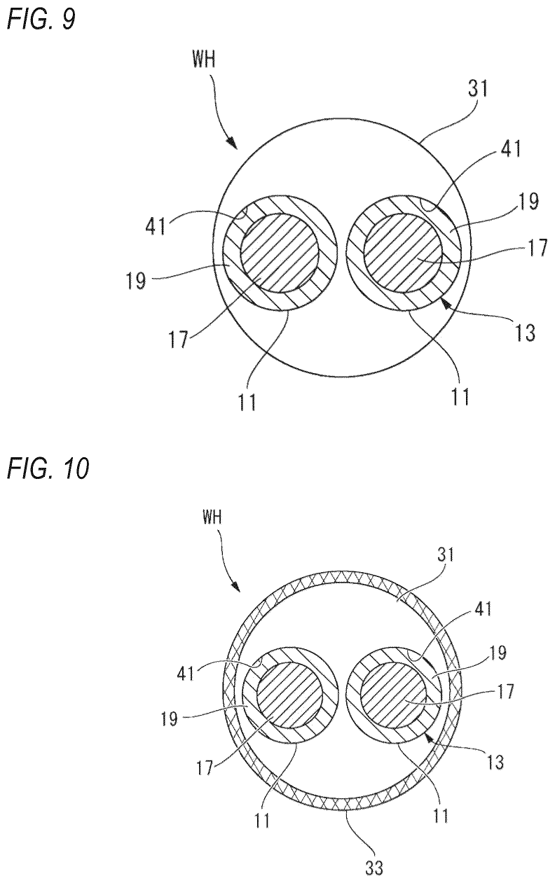

FIGS. 5 to 8 are cross-sectional views along the axial direction of the wire harness WH in the middle of manufacturing for illustrating a manufacturing process of the wire harness WH. FIGS. 9 to 12 are cross-sectional views taken along the radial direction of the wire harness WH in the middle of manufacturing for illustrating the manufacturing process of the wire harness WH.

### (Spacer Placing Step)

As illustrated in FIGS. 5 and 9, first, the electric wire bundle 13 formed by bundling the electric wires 11 is prepared, each electric wire 11 is passed through the hole portions 41 of the spacers 31, and the spacers 31 are mounted on the outer periphery of the electric wire bundle 13. Then, these spacers 31 are disposed at an interval in the longitudinal direction at a position including the water stop section S.

### (Braid Mounting Step)

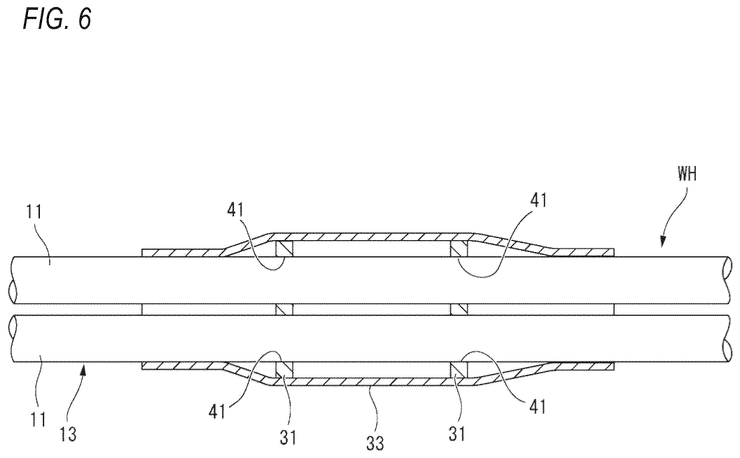

As illustrated in FIGS. 6 and 10, the tubular braid 33 is mounted on the electric wire bundle 13 on which the spacers 31 are mounted. Specifically, the electric wire bundle 13 on which the spacers 31 are mounted is passed through the braid 33, and the outer periphery of the electric wire bundle 13 including the spacer 31 is covered with the braid 33. In this way, when the electric wire bundle 13 on which the spacers 31 are mounted is covered with the braid 33, the braid 33 is expanded in diameter by the spacers 31. Accordingly, the gap between the braid 33 and the electric wire 11 is increased, and the mesh of the braid 33 is widened.

### (Forming Step)

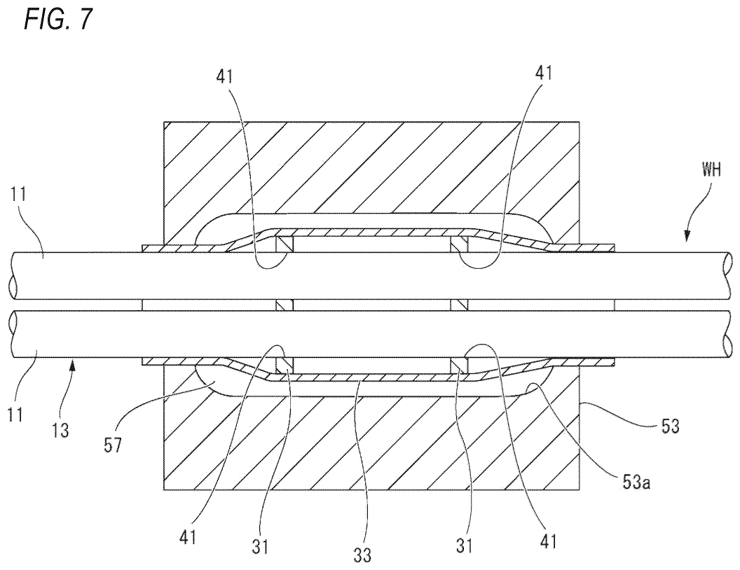

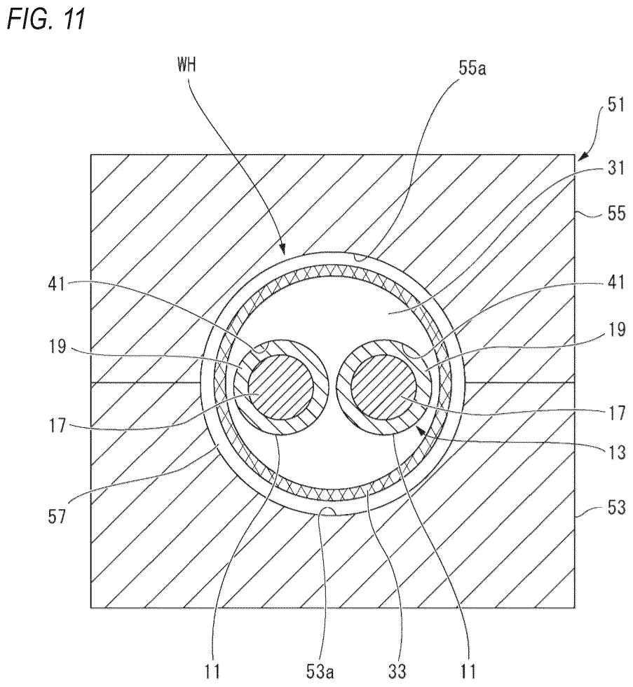

As illustrated in FIGS. 7 and 11, a mold 51 is placed at a position of the electric wire bundle 13 to which the braid 33 is mounted. The mold 51 includes a lower mold 53 and an upper mold 55. The lower mold 53 and the upper mold 55 are disposed at positions facing each other, and have molding recesses 53a and 55a on the sides facing each other. Then, the position of the electric wire bundle 13 to which the braid 33 is mounted is disposed between the lower mold 53 and the upper mold 55 of the mold 51, and the lower mold 53 and the upper mold 55 are brought close to each other and clamped. Accordingly, a cavity 57 is formed by the molding recesses 53a and 55a of the lower mold 53 and the upper mold 55, respectively, and a position of the electric wire bundle 13 that becomes the water stop section S is surrounded by the cavity 57. The cavity 57 of the mold 51 has an inner diameter larger than an outer diameter of the braid 33 mounted on the electric wire bundle 13. Therefore, when the position of the electric wire bundle 13 that becomes the water stop section S is surrounded by the cavity 57, a gap is formed between an inner periphery of the cavity 57 and an outer periphery of the braid 33.

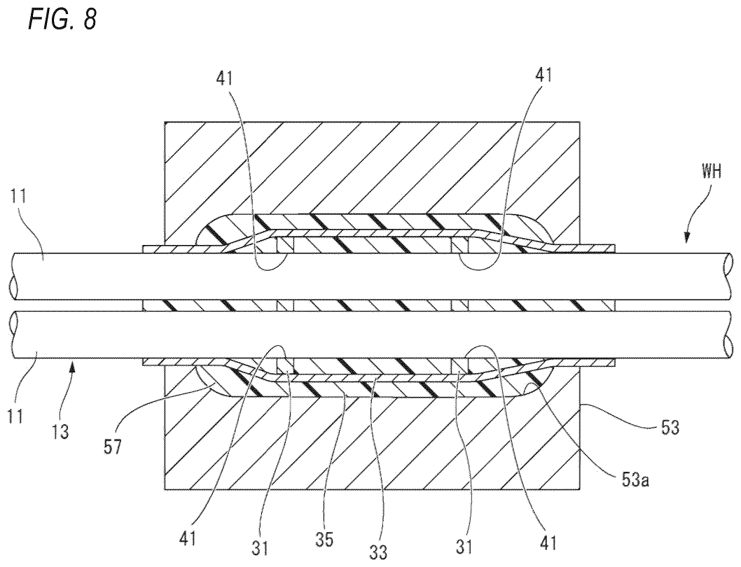

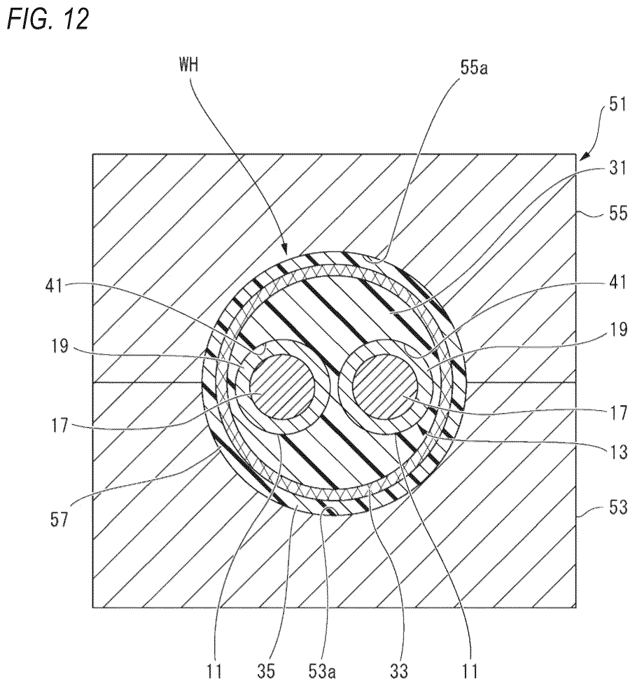

Next, as illustrated in FIGS. 8 and 12, the cavity 57 of the clamped mold 51 is filled with the heated and melted thermoplastic resin 35. Then, the melted resin 35 is filled between the electric wires 11, between the electric wires 11 and the braid 33, in the mesh of the braid 33, and on the outer peripheral side of the braid 33. Thereafter, when the resin 35 is cooled and cured, the lower mold 53 and the upper mold 55 are separated from each other, and the electric wire bundle 13 is removed from the mold 51. Accordingly, the wire harness WH in which the water stop portion 15 molded with the resin 35 is provided in the water stop section S in the electric wire bundle 13 is obtained while obtaining a shield mechanism.

As described above, according to the method for manufacturing the wire harness described above, it is possible to easily manufacture the wire harness WH in which the shielding function is obtained and the good water stop performance in the water stop portion 15 including the water stop section S is ensured. In particular, by using the mold 51 including the lower mold 53 and the upper mold 55, the water stop portion 15 can be easily molded. Accordingly, the forming step of forming the water stop portion 15 can be simplified, and manufacturing cost can be suppressed.

In the above embodiment, the number of spacers 31 mounted on the electric wire bundle 13 is not limited to a pair. For example, three or more spacers 31 may be mounted at intervals in the longitudinal direction of the electric wire bundle 13. In addition, the spacers 31 may be connected to each other in the longitudinal direction, and this configuration eliminates the need to adjust the intervals between the spacers 31. In this case, connecting portions connecting the spacers 31 to each other do not interfere with the filling of the resin 35.

The present invention is not limited to the embodiment described above, and can be appropriately modified, improved, or the like. In addition, materials, shapes, sizes, numbers, arrangement positions, and the like of components in the embodiment described above are freely selected and are not limited as long as the present invention can be implemented.

Here, features of the embodiments of the water stop structure, the wire harness, and the method for manufacturing a wire harness according to the present invention described above will be briefly summarized and listed in the following [1] to [5]. [1] A water stop structure in which a water stop portion (15) for stopping water between a water stop member (grommet 21) and an electric wire bundle (13) obtained by bundling a plurality of electric wires (11) is provided on the electric wire bundle (13), in which
the water stop portion (15) includes
   at least a pair of spacers (31) mounted on an outer periphery of the electric wire bundle (13) at a position including a water stop section(S) that requires water stop between the water stop member (grommet 21) and the electric wire bundle (13), and disposed at an interval in a longitudinal direction of the electric wire bundle (13),
   a tubular braid (33) covering the outer periphery of the electric wire bundle (13) including the spacers (31), and
   a resin (35) covering the outer periphery of the electric wire bundle (13) in the water stop section(S) together with the spacers (31) and the braid (33).

According to the water stop structure having the above configuration [1], by mounting the spacers on the outer periphery of the electric wire bundle, the braid is expanded in diameter to form a gap between the electric wire bundle and the braid, and a mesh of the braid is widened. Accordingly, the resin covering the water stop section in the water stop portion is sufficiently interposed between the electric wire bundle and the braid and enters the mesh of the braid. Therefore, by covering the outer periphery with the braid, it is possible to ensure good water stop performance in the water stop section while obtaining a shielding function.
[2] The water stop structure according to [1], in which each of the spacers (31) has hole portions (41) through which the electric wires (11) are inserted, respectively, and a gap is formed between the electric wires (11) inserted through the hole portions (41).

According to the water stop structure having the configuration of the above [2], the spacers are mounted, and the gap is formed between the electric wires, which leads to a state in which the gap between the electric wires is filled with a resin and ensures better water stop performance.
[3] A wire harness including:
the water stop structure according to [1] or [2].

According to the wire harness having the configuration of the above [3], since good water stop performance in the water stop portion including the water stop section is ensured, for example, when the wire harness is passed through a seal hole of the water stop member such as the grommet, water can be satisfactorily stopped in the water stop section between the water stop member and the electric wire bundle.
[4] A method for manufacturing a wire harness (WH) in which a water stop portion (15) for stopping water between a water stop member (grommet 21) and an electric wire bundle (13) obtained by bundling a plurality of electric wires (11) is provided on the electric wire bundle (13), the method including:
a spacer placing step of mounting at least a pair of spacers (31) on an outer periphery of the electric wire bundle (13) and disposing the spacers (31) at an interval in a longitudinal direction of the electric wire bundle (13) at a position in the electric wire bundle (13) including a water stop section(S) that requires water stop between the water stop member (grommet 21) and the electric wire bundle (13);
a braid mounting step of covering the outer periphery of the electric wire bundle (13) including the spacers (31) with a tubular braid (33); and
a forming step of filling with a resin (35) so as to cover the water stop section(S) in the electric wire bundle (13) to form the water stop portion (15).

According to the method for manufacturing a wire harness having the configuration of the above [4], it is possible to easily manufacture the wire harness in which a shielding function is obtained and a good water stop performance in the water stop portion including the water stop section is ensured.
[5] The method for manufacturing a wire harness according to [4], in which
in the forming step, a mold (51) is placed at a position of the electric wire bundle (13) to which the braid (33) is mounted, a cavity (57) of the mold (51) is disposed at a position that becomes the water stop section(S), and
the cavity (57) is filled with the resin (35) to mold the water stop portion (15).

According to the method for manufacturing a wire harness having the above configuration [5], the water stop portion can be easily molded by the mold. Accordingly, the forming step of forming the water stop portion can be simplified, and manufacturing cost can be suppressed.

### REFERENCE SIGNS LIST

11 electric wire
13 electric wire bundle
15 water stop portion
21 grommet
31 water stop member
33 tubular braid
35 resin
41 hole portion
51 mold
57 cavity
S water stop section
WH wire harness

1. A water stop structure in which a water stop portion for stopping water between a water stop member and an electric wire bundle obtained by bundling a plurality of electric wires is provided on the electric wire bundle, wherein
the water stop portion includes
at least a pair of spacers mounted on an outer periphery of the electric wire bundle at a position including a water stop section that requires water stop between the water stop member and the electric wire bundle, and disposed at an interval in a longitudinal direction of the electric wire bundle,
a tubular braid covering the outer periphery of the electric wire bundle including the spacers, and
a resin covering the outer periphery of the electric wire bundle in the water stop section together with the spacers and the braid.

2. The water stop structure according to claim 1, wherein
each of the spacers has hole portions through which the electric wires are inserted, respectively, and a gap is formed between the electric wires inserted through the hole portions.

3. A wire harness comprising:
the water stop structure according to claim 1.

4. A method for manufacturing a wire harness in which a water stop portion for stopping water between a water stop member and an electric wire bundle obtained by bundling a plurality of electric wires is provided on the electric wire bundle, the method comprising:
a spacer placing step of mounting at least a pair of spacers on an outer periphery of the electric wire bundle and disposing the spacers at an interval in a longitudinal direction of the electric wire bundle at a position in the electric wire bundle including a water stop section that requires water stop between the water stop member and the electric wire bundle;
a braid mounting step of covering the outer periphery of the electric wire bundle including the spacers with a tubular braid; and
a forming step of filling with a resin so as to cover the water stop section in the electric wire bundle to form the water stop portion.

5. The method for manufacturing a wire harness according to claim 4, wherein
in the forming step, a mold is placed at a position of the electric wire bundle to which the braid is mounted, a cavity of the mold is disposed at a position that becomes the water stop section, and
the cavity is filled with the resin to mold the water stop portion.
